(19) United States
(12) Patent Application Publication
(10) Pub. No.: US 2026/0188016 A1
(43) Pub. Date: Jul. 2, 2026

(54) OPTO-ELECTRONIC DETECTION OF MULTI-COPTERS USING PROPELLERS SPECTRAL SIGNATURES

(71) Applicants: NATIONAL RESEARCH COUNCIL OF CANADA, Ottawa (CA); HIS MAJESTY THE KING IN RIGHT OF CANADA,AS REPRESENTED BY THE MINISTER OF NATIONAL DEFENCE, Ottawa (CA)

(72) Inventors: Terrence Stewart, St. Clements (CA); Michel Picard, Ottawa (CA); Marc-Antoine Drouin, Gatineau (CA); Frank Billy Djupkep Dizeu, Gatineau (CA); Guillaume Gagne, Levis (CA)

(21) Appl. No.: 19/130,711

(22) PCT Filed: Nov. 16, 2023
(86) PCT No.: PCT/IB2023/061612

§ 371 Date: May 16, 2025

Related U.S. Application Data
(60) Provisional application No. 63/460,238, filed on Apr. 18, 2023.

(30) Foreign Application Priority Data
Nov. 17, 2022 (CA) 3187360
Mar. 10, 2023 (CA) 3193525

(51) Int. Cl. G06V 20/52; G06T 7/20; G06T 7/70; G06V 10/82; G06V 20/10

(52) U.S. Cl. CPC G06V 20/52; G06T 7/20; G06T 7/70; G06V 10/82; G06V 20/10; G06T 2207/10032; G06T 2207/20081; G06T 2207/20084

(57) ABSTRACT

A method and apparatus for the detection and tracking of drones on the basis of the distinct spectral signature of drones.

### FIELD OF THE INVENTION

This invention relates to the detection of drones and more specifically to opto-electronic detection of multi-copters using propellers spectral signatures.

### BACKGROUND

In recent years, the use of drones (also Unmanned Aerial Vehicles or UAVs) for recreational and commercial activities has grown rapidly due to their affordability and performance. This growing use raises concerns about the threats drones pose to the security of sensitive areas such as airports, prisons, industrial and military facilities. In response to these threats, drone detection methods are being actively developed. While such detection method development is driven by security, it is further applicable to drone management and operation generally.

While regulations restrict unmanned vehicles they mainly do so by regulating the qualifications for operators. In order to buttress the qualification based mode of regulation, it is desirable to apply UAV detection at, for instance, the aforementioned sensitive locations. In order to detect and track drones, there is a need to discriminate between them and other objects.

More specifically, it is desirable to increase the parameters of drone detection: efficiency, accuracy, range, etc.

It is known to use the discrete Fourier transform to determine the propellers' rotation speed from high frame rate videos, and extracting the propeller-induced drone signature as a quantitative camera-based drone signature. However, this has the disadvantage of being comparatively computationally intensive.

### SUMMARY

As per disclosed in greater detail below, according to one aspect of the invention, there is a method of detecting a drone having a propeller with a distinct propellor frequency comprising:
imaging a plurality of images of a scene with a camera,
detecting in said images, for at least one pixel of said camera, a spectral signature characteristic that corresponds to said distinct propeller frequency.

Some variants of this aspect also described include: The method wherein said spectral signature is a series of integer multiples of a base frequency; The method wherein said detection is performed by a peak detection fitting algorithm; The method wherein said detection is performed by a trained neural network; including the step of localizing the drone in the scene; the method wherein said localization is based on which said pixels exhibit said spectral signature; The method including the step of tracking any motion of said drone across said plurality of images; The method wherein said camera is a neuromorphic camera.

According to another aspect of the invention, there is an apparatus for detecting a drone having a propeller with a distinct propellor frequency comprising:
a camera for imaging a plurality of images of a scene,
a detector for detecting in said images, for at least one pixel of said camera, a spectral signature characteristic that corresponds to said distinct propeller frequency.

Some variants of this other aspect also described include:

The apparatus wherein said detector is configured to identify that said spectral signature is a series of integer multiples of a base frequency; The apparatus wherein said detector is configured to perform a peak detection fitting algorithm to identify peaks; the apparatus wherein said detector comprises a trained neural network; the apparatus said detector is configured to localize the drone in the scene; the apparatus wherein said detector localizes based on which said pixels exhibit said spectral signature; the apparatus of claim 14 wherein said detector further tracks any motion of said drone across said plurality of images; the apparatus wherein said camera is a neuromorphic camera.

### BRIEF DESCRIPTION OF THE DRAWINGS

The drawings have not necessarily been drawn to scale. Similarly, some components and/or operations can be separated into different blocks or combined into a single block for the purposes of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

FIG. 1 is an example of (first row): three drone detections, for each detection a thumbnail of the drone and the frequency signature where a red frame indicates the detection of a drone; while a green one indicated no detection; (second row) an example of a helicopter showing a slower propeller signature that does not overlap with drone's one; (third row) non-detections (green) of a bird and backgrounds showing (far right) where the frontier between the treetops and the sky is generating a frequency signature when the camera is panning, but no drone is detected based on the signature.

FIG. 2 shows drone detection (top left) and non-detections using a 300 mm mirror lenses.

FIG. 3 shows drone detection while an uncalibrated camera is panning.

FIG. 4 shows drone detection with an event camera against a blue-sky background with the blue box indicating the automatically tracked drone; and a display of the measured frequency at each pixel inside the blue box; and the histogram of frequencies, showing the characteristic peak around 5000 rpm; and a drone flying directly overhead.

FIG. 5 shows drone detection with an event camera against backgrounds that are difficult for traditional methods.

FIG. 6 shows drone detection with an event camera mounted on another drone.

FIG. 7 shows an example histogram generated by algorithm with each pixel.

### DETAILED DESCRIPTION

Systems and methods for aerial unmanned vehicle (for example, drone) detection are described herein. While the disclosure uses the term “drone,” one of ordinary skill in the art would understand that the discussion would apply to other similar unmanned vehicles. Various implementations discussed below address different aspects of the infrastructure needed for detecting drones

In the following description, for the purposes of explanation, numerous specific details are set forth in order to provide a thorough understanding of implementations of the present technology. It will be apparent, however, to one skilled in the art that implementations of the present technology can be practiced without some of these specific details.

The techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some implementations,” “according to some implementations,” “in the implementations shown,” “in other implementations,” and the like generally mean the particular feature, structure, or characteristic following the phrase is included in at least one implementation of the present technology, and can be included in more than one implementation. In addition, such phrases do not necessarily refer to the same implementations or different implementations.

Neuromorphic cameras are a type of camera that can be well suited for detecting uncrewed aerial vehicles. Unlike traditional cameras that record the intensity of light and produce an image of the target, a neuromorphic camera records variation in the light intensity in time. This can be thought of as a differential or first order derivative of the intensity.

These changes in light-intensity, or events, are why neuromorphic cameras are commonly called event cameras. Specifically for the purposes of this invention, it is particularly beneficial to employ pixilated event cameras, which are binary i.e. each pixel event represents a change (positive or negative) in intensity.

Event cameras are advantageous over traditional cameras for high-speed imaging since, for the same image size, they transmit less data allowing for faster image capture. This is because only the variation in light intensity is recorded in an event camera, allowing for the data stream to contain only the data of interest (i.e. a moving drone blade) and not contain nonessential information (i.e. stationary background).

A drone detecting virtual fence is envisioned as a low-cost networked situational awareness device to quickly alert that a drone has entered a zone of interest.

For a virtual fence, event cameras present an advantageous substitute for traditional camera solutions, as they significantly reduce the amount of data that must be processed as opposed to high-speed cameras

While the maximum detection range (in metric unit) of a system is a performance criterion of the upmost important for end user; scientist and engineer may be interested in characterizing the maximum detection range using the minimum detectable size of a drone in the camera image. This allows us to compare two systems with different optical configurations or to predict the performance of a system when varying its optical configuration. For example, having a narrow field of view will lead to a farther detection distance than is achievable with a wideangle lens, simply because the drone will occupy more pixels in the narrow case.

The pixel coordinates (x, y) corresponding to the projection of a 3D point (X, Y, Z) can be computed as:

$$[ \begin{matrix}x \\ y\end{matrix} ] = \frac{f}{sZ} [ \begin{matrix}X \\ Y\end{matrix} ] + [ \begin{matrix}{c}_{x} \\ {c}_{y}\end{matrix} ] \qquad ( 1 )$$

where f is the focal length, s is the pixel size and □cx, cy□□ is the principal point [Hartley2004]. Given two 3D points (X1, Y1, Z1) and (X2, Y2, Z2) located at the same distance from the camera (i.e. Z1=Z2) and assuming, without loss of generality, that Y1=Y2, the transformation from the distance between the 3D points ΔX (i.e. |X2−X1|) and distance Δx in the image (i.e. x2−x1) is given by:

$${Δ}_{x} = \frac{f}{sZ} {Δ}_{X} \qquad ( 2 )$$

Given the minimum size Δxₘᵢₙ in pixel for which a drone can be detected in an image, and

$$\frac{1}{Z} {Δ}_{{X}_{UAS}}$$

and the actual physical size. From Eq. 2, a drone can be detected when

$$\frac{s}{f} Δ {x}_{min} \leq \frac{1}{Z} {Δ}_{{X}_{UAS}} \qquad ( 3 )$$

This inequation allows us to determine the maximum range Z at which a drone of known size can be detected given the intrinsic parameters of the camera. In our experiments for both high-speed and event-based cameras, we can typically detect a drone in the image when it covers about 12 pixels from the tip of a propeller to the tip of the other visible propeller. It is sometimes useful to rewrite this equation as a function of the field of view FOV rather than the focal length. This allowed to examine trade-off between field of view and maximum detectable distance. The relation between FOV and f is given by:

$$f = \frac{s \times {x}_{size}}{2 tan \frac{FOV}{2}} \qquad ( 4 )$$

where x_{size} is the number of pixels of the camera along the X axis.

Note that when scaling the performance of camera-based drone detection system to larger distance, the variation of the air's reflective index along the line of sight may increase and this may affect Δxmin. This is not considered in Eq. 3.

### 2.2 UAS Speed Constraints

When a pixel is viewing the same propeller (even when the drone is moving) for a sufficient prolonged period, it is possible to detect the propellers without having to track the UAS. This requires the maximum speed in the image (pixel per second) of the propeller to be small enough. Explicitly,

$${V}_{max}^{p} \times {t}_{min} < \frac{f \times size}{sZ} \qquad ( 5 )$$

where size is the length along the direction of motion in 3D space (further described in section 2.2.1) and tₘᵢₙ is the minimum time interval needed to identify the propeller signature and it is discussed in section 2.3. When the inequation Eq. 5 is respected, a moving UAS that generates lift using propellers can be detected using its frequency signature without requiring tracking.

When rotating, a propeller defines a circle in 3D space. The projection of this circle in the image plan of a camera creates a conic. Of interest are the cases where this conic is an ellipse or a line (degenerate conic). Note that in practice, because of the shape of the propellers, this line (or ellipse with large eccentricity) registers as a shape somewhat like a rectangle. A 3D vector representing the direction of displacement of the drone centred at the centre of the rotating propeller forms a line in the image plane. The interception of this line and the conic defines the length along the direction of motion in image space which can be back projected in 3D space to become the length along the direction of motion in 3D space. Note that it can vary significantly depending on the direction of motion and relative position and orientation of the drone with respect to the camera, with the worst possible case representing a movement perpendicular to the degenerate conic. Explicitly, this is the case of a camera is viewing the drone from the side while it is moving straight up or down.

If we want to scan the sky for drones, or to track one, then it is worthwhile to examine the effects of camera movements associated with a Pan-Tilt (PT) unit. Pure translational movements are equivalent to a fixed camera with a moving drone and are not discussed further. When the rotation axis of the PT unit is sufficiently close to the origin of the camera coordinate system and that the drone is sufficiently far from the camera, the parallax between the image should be negligeable. For this special case of movement, it is possible to calibrate the Pan-Tilt unit such that an homography can be computed that would align the image to compensate for the Pan-Tilt unit movement. This calibrated Pan-Tilt configuration is part of our research planning. The underlying principle is like the one used in the panorama features built-in smartphones. In the remainder of this manuscript, we assume that the Pan-Tilt used is not calibrated and the maximum angular speed can be computed and similarly to Eq.5, we have

$$f tan ( {V}_{max}^{θ} \times {t}_{min} ) < \frac{f \times size}{sZ} \qquad ( 6 )$$

Combining Eq 5 and Eq. 6, we obtain

$$f tan ( {V}_{max}^{θ} \times {t}_{min} ) + {V}_{max}^{p} \times {t}_{min} < \frac{f \times size}{sZ} \qquad ( 7 )$$

When the previous inequation is not respected, a moving UAS that generates lift using propellers cannot be directly detected using frequency signature without first tracking the UAS. In the next section we examine the relation between the time tₘᵢₙ, the rotation rate of the propeller and the imaging technology used.

The value of tₘᵢₙ depends on the type of camera technology used for the acquisition and the rotation rate of the propellers (RPM).

For a system based on event-based camera, the evaluation of tₘᵢₙ is more complex and depends on the response of pixel when stimulated by a rotating blade. Four events are expected to register for each rotation of the propeller.

Two events should register in an exceedingly small interval followed by a longer interval and two other consecutive events. Explicitly, when the propeller rotates a blade should enter in the field of view of a pixel (first event) and, since the propeller is thin, it should immediately exit the field of view (second event). After half a turn of the propeller, the other blade of the propeller should enter the field of view (third event) before quickly exiting the field of view (fourth event). A single rotation of the propellers allows to estimate the rotation rate of the propellers.

$${t}_{min} = \frac{60}{{RPM}_{max}} \qquad ( 8 )$$

Note that event camera can miss some events. Missed events lead to measuring a period of rotation that is double (or triple or quadruple and so on) of the actual period (i.e., the subharmonics of the actual propeller frequency), following a regular and predictable pattern that is part of the characteristic signature for the drone. The contrast between the propellers and the background is also a factor.

For extremely high-speed cameras, the value of tₘᵢₙ can be computed in a similar fashion as for event cameras. When the frame rate is sufficiently high to allow a pixel to view a rotating propeller on two consecutive frames, similar processing as for event-based camera can be used to compute the frequency signature. Explicitly, for each pixel the temporal derivative can be computed and thresh-holded to determine if an event occurs. Given the current technology, designing a portable system that would use an extremely high-speed camera that could mimic an event-based camera is not practical in terms of power consumption and this case is not discussed further.

For less extreme high-speed cameras the Discreet Fourier Transform (DFT) is used on the temporal sequence of intensity changes. Using Nyquist,

$${t}_{min} = 2 \frac{60}{{RPM}_{max}} , when fps \leq \frac{2}{60} {RPM}_{max} \qquad ( 9 )$$

Otherwise, the high-speed camera cannot be used to compute the rotation of the propellers because of aliasing. In that case, a signature that could correspond to the one generated by a drone can be computed as

$${t}_{min} = 2 \frac{60 fps}{{RPM}_{max}} \qquad ( 10 )$$

For the following experimental results, an 8-bit Emergent Vision Camera (resolution: 1936×1080, Frame rate: 500 Hz) equipped with a 100 and 300 mm lens was used. It was mounted on a tripod and observed the sky from either a fixed position or while panning to follow putative target in the sky. At this step, the recorded data was saved on computer hard drive for offline post-processing using a Geforce RTX 3080 GPU.

The frequency signature-based method was tested with different entities (drones, helicopter, birds, flies) flying against diverse backgrounds (cloudless sky to scattered clouds, trees, mountains) at different distances. A person skilled in the art will understand that the individual components are interchangeable with many commercial substitutes.

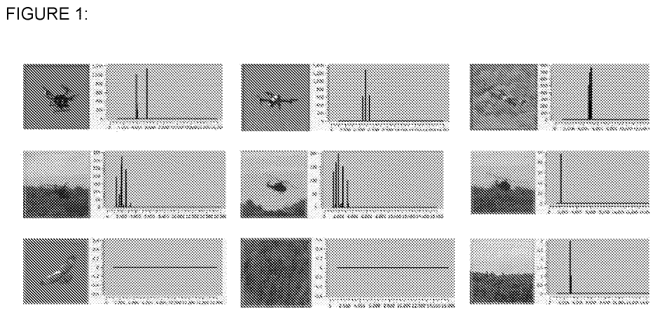

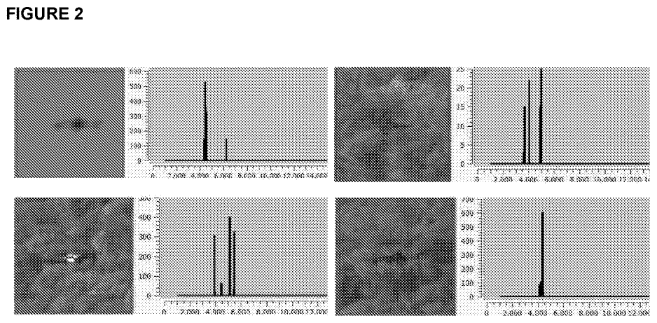

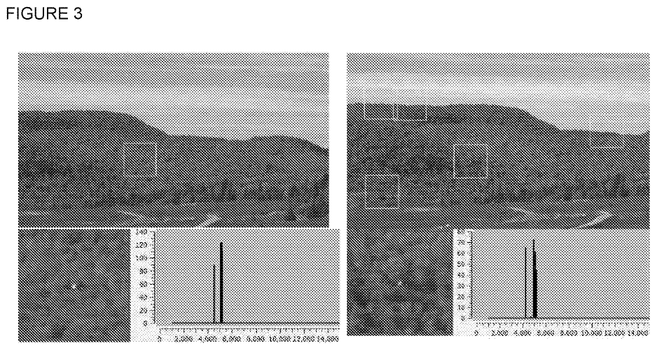

FIG. 1 shows examples of signatures of drone and non-drone entities using a static camera configuration. Of interest are the signatures of a helicopter. The method detects a propeller, but at lower frequency than the ones of drones. FIG. 2 shows more challenging scenes with a complex forest background. Moreover, the drones can be difficult or even impossible to differentiate from the background using only their appearance. Also, note that the method is robust to out-of-focus blurring which is important when working with large magnification. FIG. 3 shows results of camera panning when the algorithm is not tracking the drone. As expected by Eq. 6, the method works well even if it was not originally designed for this type of configurations. That been said, the right side of the figure shows multiple drone candidates (the yellow rectangles), but only one has the frequency signature of a drone. Two of the other candidates are shown in the last row of FIG. 1. The right most candidate has a low frequency signal which is generated by the non-level tree top combined with the horizontal panning of the camera. A faster camera movement could have generated a false positive since the frequency signature would be like the one of drones. A calibrated Pan-Tilt unit would mitigate those type of detection errors.

According to one aspect of the invention an event based camera system is composed of a Raspberry Pi 4 that interfaces with a DVXplorer 640×480 event-based camera from IniVation. The Raspberry can provide the classification (drone vs. no drone) at 100 Hz using the current Python implementation. The zoom lens shipped with the DVXplorer was used and the field of view was adjusted to match the one of a GoPro Hero 8 for comparison. The system was powered by a battery bank and could be hand-held or mounted on a tripod. For the airborne sequences, the camera, Raspberry, and battery were mounted on a DJI Matrice 200 drone. The camera was installed on camera-stabilizing mount to reduce vibration. The total system consumes about 5.1 W. The software is based on Terrence C. Stewart, Marc-Antoine Drouin, Michel Picard, and Frank Billy Djupkep Dizeu, Antony Orth, Guillaume Gagné. A Virtual Fence for Drones: Efficiently Detecting Propeller Blades with a DVXplorer Event Camera. In International Conference on Neuromorphic Systems (ICONS 2022), Jul. 27-29, 2022, Knoxville, TN, USA. ACM, New York, NY, USA, 7 pages. https://doi.org/10.1145/3546790.3546800, with the same drone detection algorithm but an added separate tracking algorithm (indicated with a blue bounding box in the figures below).

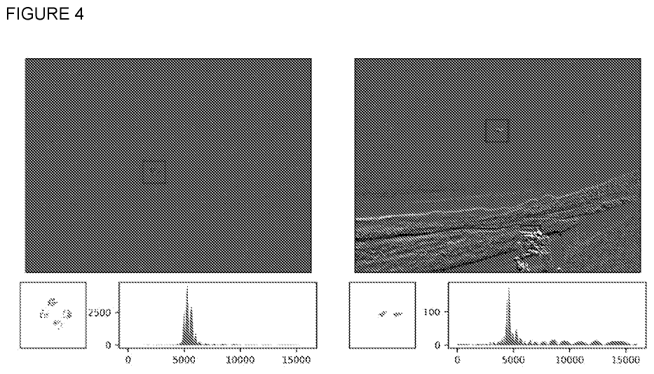

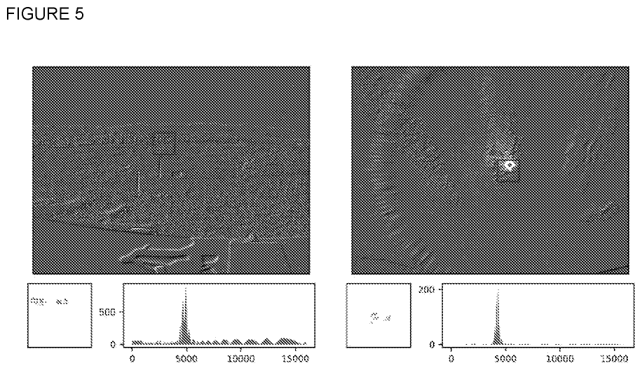

FIG. 4 shows examples of drone detection against a blue-sky background, although here the detection system is hand-held, rather than on the ground pointing up. FIG. 5 gives more complex examples like the one in the previous section (FIG. 3) where the drone is seen against a hilly background. Furthermore, FIG. 5 gives an example of a drone seen directly in the sun, which would be a particularly challenging configuration for a regular camera.

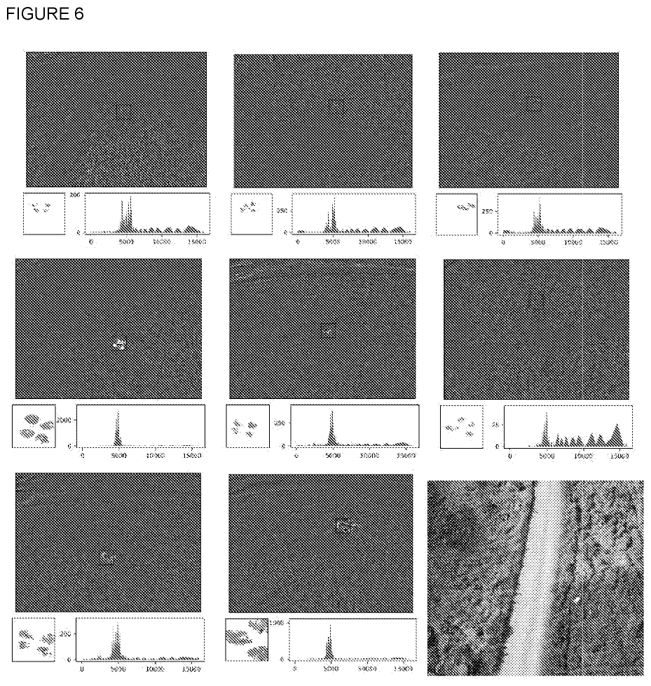

FIG. 6 shows drone detection with an event camera pointing down and mounted on a DJI Matrice 200 drone. This is a very difficult scenario, given the complex background and the movement of both drones. Furthermore, it is noted that the detection and tracking algorithms were not designed for this case. Rather, they were designed for a static camera, but they are still performing well here. The reason for this success is the fact that the frequency signature of the propeller blades is a very robust indication of the presence of a drone.

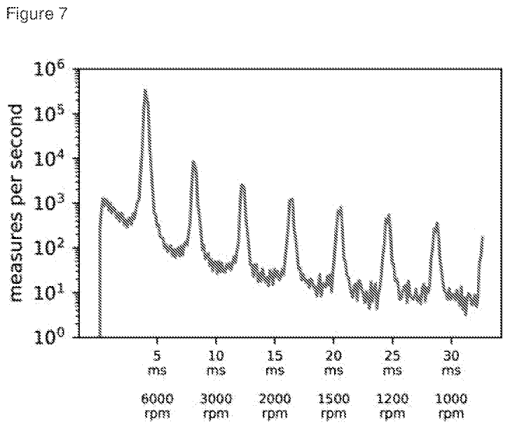

As mentioned above, drone propeller rotation recognition will occasionally miss, causing the mirage of n-tuple frequencies. See the histogram of FIG. 7. According to one aspect, for propeller detection, detection of propeller frequency histogram can be pixelwise, and binned locally to generate bounding areas as noted above.

Moving objects without high-frequency components (i.e. non-drones) will still produce some ON->OFF->ON measurements in the ranges covered by our histogram, but they will not produce the characteristic sub-harmonic peaks.

In order to distinguish the temporal pattern of a drone from other objects, according to one aspect, fitting algorithms and peak detection may be employed on a histogram such as FIG. 7. However, according to another aspect, a simple single-hidden layer neural network can perform this task in a much less computationally expensive manner.

For a neural network the input histogram information consists of 256 32-bit integers. Each bin in the histogram is 128 microseconds wide, covering period measurements up to 32.768 milliseconds (256×128 μs). For a two-bladed propeller, this corresponds to frequencies down to 915 rpm. Any measurement of lower frequency is beneficially discarded.

Given the large range of values in this data, the log of these values (setting to 1 any bins with 0 events) is preferred. The values may be normalized, ensuring that the overall number of measurements is not included in the input to the network. The number of measurements is a feature of the background environment, not of the drone itself. This corresponds to normalizing image input in typical image recognition neural networks, where the overall brightness of the image is not meant to be important for classification.

Optionally the Fourier transform of the histogram may also be (also in a log scale and normalized) included as part of the input to the network. Preferrable, a discrete Fourier transform is used.

According to still another aspect of this invention, tracking of the drone object in the figures is possible. Regardless of whether detection is performed according to peak detection or neural network, a tracking algorithm such as the one described in Section III.B of ‘A miniature low-power sensor system for real time 2D visual tracking of LED markers’ https://ieexplore.ieee.org/document/6181669 may be applied to those results.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order, and some processes or blocks may be deleted, moved, added, subdivided, combined, and/or modified to provide alternative or sub-combinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges. Those skilled in the art will also appreciate that the actual implementation of a database may take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements, blocks and acts of the various implementations described above can be combined to provide further implementations.

Any patents and applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects may likewise be implemented in a computer-readable medium. Accordingly, the inventors reserve the right to add additional claims after filing the application to pursue such additional claim forms for other aspects of the technology.

1. A method of detecting a drone having a propeller with a distinct propellor frequency comprising:
imaging a plurality of images of a scene with a camera,
detecting in said images, for at least one pixel of said camera, a spectral signature characteristic that corresponds to said distinct propeller frequency.

2. The method of claim 1 wherein said spectral signature is a series of integer multiples of a base frequency.

3. The method of claim 1 wherein said detection is performed by a peak detection fitting algorithm.

4. The method of claim 1 wherein said detection is performed by a trained neural network.

5. The method of claim 1 further including the step of localizing the drone in the scene.

6. The method of claim 5 wherein said localization is based on which said pixels exhibit said spectral signature.

7. The method of claim 6 further including the step of tracking any motion of said drone across said plurality of images.

8. The method of claim 1 wherein said camera is a neuromorphic camera.

9. An apparatus for detecting a drone having a propeller with a distinct propellor frequency comprising:
a camera for imaging a plurality of images of a scene,
a detector for detecting in said images, for at least one pixel of said camera, a spectral signature characteristic that corresponds to said distinct propeller frequency.

10. The apparatus of claim 9 wherein said detector is configured to identify that said spectral signature is a series of integer multiples of a base frequency.

11. The apparatus of claim 9 wherein said detector is configured to perform a peak detection fitting algorithm to identify peaks.

12. The apparatus of claim 9 wherein said detector comprises a trained neural network.

13. The apparatus of claim 9 said detector is configured to localize the drone in the scene.

14. The apparatus of claim 13 wherein said detector localizes based on which said pixels exhibit said spectral signature.

15. The apparatus of claim 14 wherein said detector further tracks any motion of said drone across said plurality of images.

16. The apparatus of claim 9 wherein said camera is a neuromorphic camera.
